(19) United States
(12) Patent Application Publication
(10) Pub. No.: US 2016/0330408 A1
(43) Pub. Date: Nov. 10, 2016

(54) METHOD FOR PROGRESSIVE GENERATION, STORAGE AND DELIVERY OF SYNTHESIZED VIEW TRANSITIONS IN MULTIPLE VIEWPOINTS INTERACTIVE FRUITION ENVIRONMENTS

(71) Applicant: Filippo Costanzo, Los Angeles, CA (US)

(72) Inventor: Filippo Costanzo, Los Angeles, CA (US)

(21) Appl. No.: 15/096,481

(22) Filed: Apr. 12, 2016

Related U.S. Application Data
(60) Provisional application No. 62/146,524, filed on Apr. 13, 2015.

(51) Int. Cl. H04N 7/173; H04N 7/18; H04N 5/232; H04N 21/214; H04N 21/8547; H04N 21/234; H04N 21/2362; H04L 29/06; H04N 21/218

(52) U.S. Cl. CPC H04N 7/17318; H04L 65/601; H04N 7/188; H04N 5/23206; H04N 21/21805; H04N 21/8547; H04N 21/23424; H04N 21/2362; H04N 21/2143

(57) ABSTRACT

A method of providing interactive and immersive fruition of live and/or on-demand events delivered through communication systems and formats that can allow personalized and interactive fruition for each of the participating users. The invention devises a method of generating, storing and delivering the audio-video-data information that are needed in order to enable the users to interactively change their viewpoint of the event being depicted, and to do so while providing a user experience that portrays the actual movement, in the tri-dimensional space of the location (theater, stadium, arena and the like) to one of the available camera views (real and/or virtual). The method of the present invention allows for the optimization of the bandwidth usage and of the required processing resources on both the server and the client side and is scalable to any number of interactive users.

This application is related to, and derives priority from, U.S. Provisional Patent Application No. 62/146,524 filed Apr. 13, 2015. Application 62/146,524 is hereby incorporated by reference in its entirety.

### BACKGROUND

1. Field of the Invention

The present invention relates generally to the field of streaming video/audio and more particularly to interactive and immersive fruition of live and/or on-demand events delivered through communication systems and formats that can allow personalized and interactive fruition for each of the participating users

2. Description of the Prior Art

Internet Video Streaming has progressed over the last few years, and consumers who watch streaming video online represent today an important technology trend. Currently, the vast majority of media programs (audio-video), either meant for the traditional broadcast market or designed for interactive fruition, can be streamed online over the internet, either live or on demand. These types of streams are generally capable of carrying the audio-video-data information, for example contained on remote servers, to the client computer or mobile and wearable device/s.

The development of advanced codecs and streaming technologies has permitted the introduction of innovative capabilities like adaptive bitrate streaming and multi-angle interactive viewing. Experimental techniques have also entered the television market for the generation of free-viewpoint instant replays and highlights applied to the broadcast fruition of live events crucial moments like in many sports pivotal games (world series, super bowl etc.), where synthetic and real views can be provided from a multitude of real feeds. The advent of even more immersive forms of personal displays (VR etc.) opens the door to a major paradigm shift of a personalized fruition that would bring such technologies under the control of each single user live and/or on demand.

### SUMMARY OF THE INVENTION

The present invention relates to the fields of interactive and immersive fruition of live and/or on-demand events delivered through communication systems and formats that can allow personalized and interactive fruition for each of the participating users (e.g. internet streaming etc.). More specifically the invention devises a method of generating, storing and delivering the audio-video-data information that are needed in order to enable the users to interactively change their viewpoint of the event being depicted, and to do so while providing a user experience that portrays the actual movement, in the tri-dimensional space of the location (theater, stadium, arena etc.), to one of the available camera views (real and/or virtual). The method of the present invention allows for the optimization of the bandwidth usage and of the required processing resources, CPUS and GPUs on both the server and the client side.

### DESCRIPTION OF THE FIGURES

Attention is now directed to several figures that illustrate features of the present invention:

FIG. 1 shows generation of a synthetic view from a system of real cameras in a stadium.

FIG. 2 shows generation of a synthetic view from system of real cameras in a theater.

FIG. 3 shows examples of possible transitions between five camera feeds.

FIG. 4 shows the transitions of FIG. 3 with related timing information.

FIG. 5 shows a system with 1-2, 2-3 and 3-4 transitions on demand.

FIG. 6 shows a system with 1-2, 1-3 and 3-4 transitions on demand.

FIG. 7 shows a system with transitions from both real feeds and synthetic feeds.

Several drawings and illustrations have been presented to aid in understanding the present invention. The scope of the present invention is not limited to what is shown in the figures.

### DESCRIPTION OF THE PREFERRED EMBODIMENTS

The present invention applies to the field of audio-visual media creation and fruition, and to systems and methods capable of providing the user experience of watching a nearly unlimited number of available real and/or synthetic audio-video feeds (pertaining to an event) from which the desired one can be interactively chosen at any given moment by the user while the uninterrupted continuity of fruition of audio and video is maintained.

The current capability of performing (locally or remotely) most, or all, of the complex calculation required to synthesize additional viewpoints, given a discrete number of actual audio-video-data acquisition points (digital video—light fields—mixed sensors fusion etc.), allows for the introduction of more articulated hybrid data formats in order to represent the whole complexity of the situation being captured.

The present invention formulates and uses a “model based” approach where each data layer concurs to an effective multi-dimensional and dynamic representation of all of the physical characteristics pertaining to the location and to the event [“SCENE” (location+event data)] being portrayed. In a possible embodiments they will include:
1. AUDIO and VIDEO from traditional and/or digital sources.
2. 3D GEOMETRY (laser scan—image based etc.).
3. COLORS, MATERIALS, BRDF.
4. LIGHTING.
5. AUDIO IMPULSE RESPONSE positional sound analysis.
6. LIGHT FIELD IMAGE AND VIDEO processing from specialized image sensors.

Such information are effectively cross-calibrated and merged into a dynamic model of the SCENE which contains both INVARIANT (most physical elements and characteristics that are not changing for a part or the whole duration of the event, like location main architectural elements etc.) and VARIANT (most physical elements and characteristics that are dynamically altered for a part or the whole duration of the event, like audience, actors, singers, dancers etc.)

Possible embodiments of the current invention may include said discrete audio and video sources as well as a number of virtually unlimited vantage points of view. Such discrete sources may be in the format of interactive panoramic video or hybrid 3D-video Light-Fields encapsulating the venue, whole or in part, or more simply a predetermined portion of the physical space surrounding the audio-video-data capture stations. Furthermore dynamic transitions in the tri-dimensional space of the SCENE being represented can be provided at each user's request for a personalized interactive fruition.

Possible applications may include immersive Virtual Reality, interactive Television and the like.

The present invention aims to provide the user with the feeling of “being there” (a virtual presence at the location where the event occurs), placing her/him inside an environment (for example a theater, stadium, arena etc.) in which she/he can choose from virtually unlimited points of views and available listening positions. The method is comprised of the following steps:

### On Location

### 1. 3D Data Acquisition (Offline)

### Analysis and Reconstruction of the Invariant Physical Scene

“Scene Invariant Data” is considered the tri-dimensional representation of the event and its location as it is possible to be determined via:
Image Based 3D Reconstruction, for example: structure from motion type of algorithms or other comparable approach.
3D Scan (Laser—Lidar) and 3D sensors augmented devices like Microsoft Kinect, etc.
LIGHT-FIELD image and video capture.
HDRI acquisition of “deep color” information under multiple lighting conditions.
BRDF analysis and reconstruction from images.
Audio Impulse Response information for positional listening virtual reconstruction.

### 2. 3D Data Acquisition (Real-Time)

### Analysis and Reconstruction of the Variant Physical Data

“Scene Variant Data” represents all the possible variant elements introduced, for example, during a performance like a theater piece or music concert, such as audiences, actors, singers, variable scenery movements etc.; such variations on the scene model can be determined via:
Model Based (see above) calibration (reconciliation of 2D and 3D data) of Audio-Video acquisition systems (traditional cameras, light field cameras, positional audio stations etc.) for each of the available audio-video capture stations in the venue.
Extraction of dynamic, per pixel, 3D information and depth maps.
Analysis and separation of variant information (as defined above).
Determination of the Virtual Acoustic Environment of scene locale.
   ON LOCATION and/or ON REMOTE SERVER/s

### 1. Progressive Generation and Streaming of Synthetic View Transitions

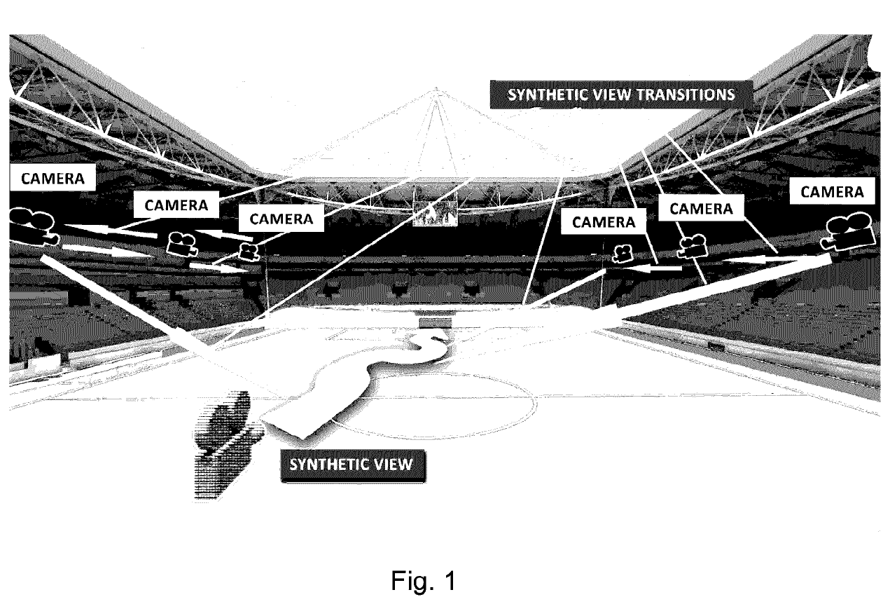

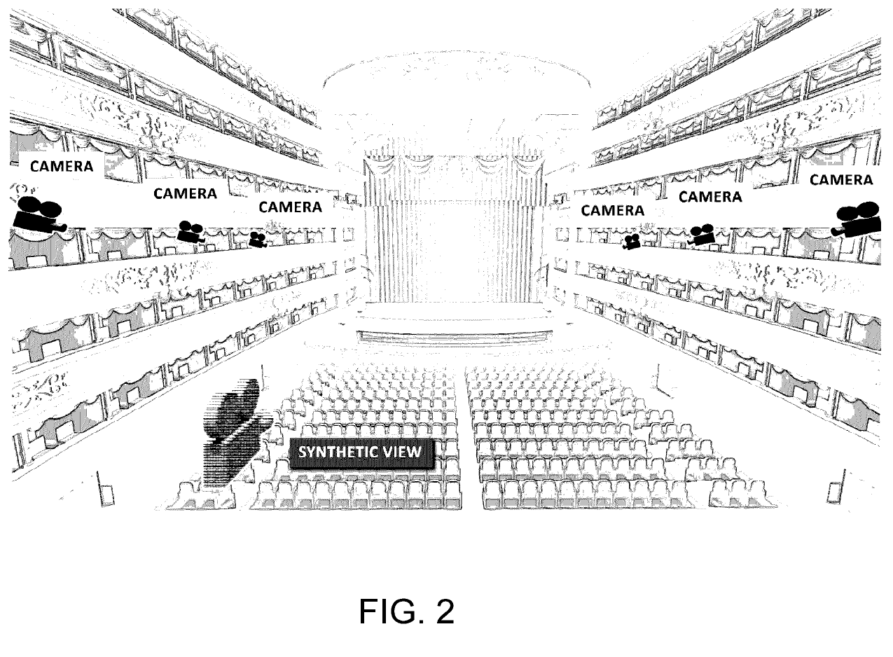

“Scene Synthetic View” represents a vantage point that does not correspond to any of the available audio-video-data capture stations present in the venue (See FIGS. 1-2). Video/audio feeds may be real (from real devices such as cameras) and synthetic. Synthetic feeds are video/audio streams that are synthesized according to techniques known in the art from two or more (usually many) real feeds.

“Scene Synthetic View Transitions” (“3D transitions”) represent all the possible trajectories (of a determined duration [user or system]) in the tri-dimensional space of the venue (theater, stadium, arena etc.) among some or all of the available audio-video capture stations present in the venue (See FIGS. 1-2) including real and synthetic feeds.

Such transitions, opposite to a simple camera switch, allow the user to “virtually move” through the location via a synthesized trajectory in the tri-dimensional space of the location, between a vantage point and the next one of choice.

In a preferred embodiment of the current invention, to obviate to the complex and resource intensive issues of performing the needed calculations on demand for each of the participating users (connected to the communication channel [internet streaming and the like], a method of progressive generation of view transitions is used in order to achieve the desired user experience while being efficient and scalable in terms of resources being used.

The method includes several steps, one of which includes computing the 3D trajectories between each camera position, both real and synthetic (audio-video-data capture station) taking into account both “scene invariant” and “scene variant” features in order to maintain an uninterrupted audio-video fruition while enjoying a seemingly “free roaming” capability, on demand, inside the location.

This is achieved in the following steps:
1. Progressive generation, at regular intervals (fractions of a second in the present embodiment) of all possible 3D transitions (among all available points of view [audio-video-data capture stations).
2. Generation of appropriate positional audio transition.
3. Incremental generation of the necessary audio-video-data files containing the 3D transitions as they are created in successive time intervals (e.g. each ½ second) and synchronized and time aligned with the audio-video-data capture stations present in the venue.
4. Generate, as needed, time stacked audio-video-data 3D transition files depending on the set Rendering and Duration time intervals (e.g. a transition lasting 1 second but calculated every ½ second might require 2 (two) parallel audio-video streams).
5. Update manifest file (or equivalent) of files status, time alignment and availability.

The user interface then interprets the user's input to determine the path towards the desired direction in 3D space, at which point the appropriate transition audio-video-data snippet is streamed without audio-video interruption in order to mimic the feeling of moving inside the space where the event being depicted occurs.

The desired level of interaction described in the present invention is achieved with a substantial optimization of computing resources. The tri-dimensional transitions, if executed on demand at the request of each user at any instance in time, would require a substantial amount of CPU-GPU resources either on location or in a Graphic Cloud Server.

Performing such task, in real time, at every user request would require an amount of resources that, at its upper limit, would need to scale proportionally with the number of connected users (e.g. 1000 users, each requesting one of the possible 3D transition at slightly different instances in time would need, in the worst case 1000, single or multiple, calculation units (CPU—GPU) to accomplish the task.

In the preferred embodiment a calculation of 3D transitions among all of the available cameras for a live or a on demand show is performed at every fraction of a second (at ½ of second for instance) for all available views and in all of the possible permutations, exploiting the small buffering delay of server to client connection and providing an experience that is perceptually indistinguishable from the one obtained via a dedicated on demand calculation.

In such an embodiment, in the case of 3D transitions calculated every ½ of a second and lasting 1 second each, a fixed number of resources, that is only proportional to the number of camera view points (audio-video-data capture stations) being interpolated, can be easily determined.

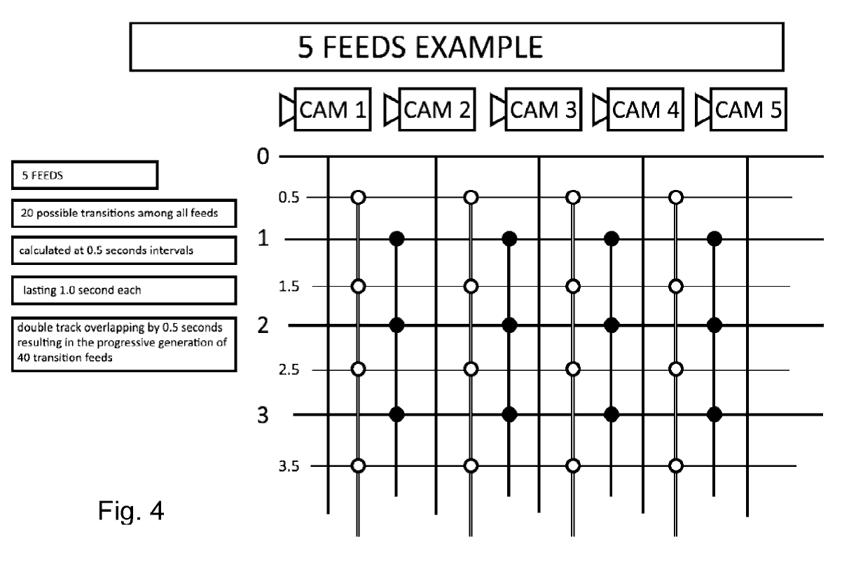

For instance an available number of 5 view points would produce (FIG. 4B):
1. 5 (five) audio-video-data feeds (standard, panoramic or light-field)
2. 20 (twenty) 3D transition audio-video-data feed progressively calculated each ½ of a second leading to a total number of audio-video-data files for the 3D transition of 40.

Such method permits an almost infinite scalability, with an amount of computing resources, which is proportional only to the number of views (hence the variety of the experience being provided) and completely independent from the number of requests sent by different users to the system.

In the above example, for instance, only 5 feeds are sent to the remote server which at ½ second intervals calculates incrementally the remaining 40 (using only 40 single or multiple CPU—GPU units) giving each user the possibility of moving in the tri-dimensional space of the event with an experience that is analog to on demand calculation and does not present any of the scalability issues explained above since at every ½ of a second 1, 10, 100 or 100000 user can request those 3D transitions calculated by only 40 units.

Such an example extends to larger numbers of feeds maintaining the same proportional relation between existing and synthesized audio-video-data elements.

The steps being described here can be performed on the audio-video sources than can be obtained via the methods described above in the previous paragraphs. Such sources might be available offline to be pre-processed or could be streamed and interpreted in real-time by the server and/or the client.

Turning to the figures, FIG. 1 shows the generation of a synthetic view from a set of real cameras in a sports stadium. FIG. 2 shows the generation of a synthetic view from a set of real cameras in a theater. While the generation of synthetic views from sets of real cameras is known in the art, FIG. 1 also shows with arrows between the cameras possible sets of transitions between the cameras. Synthetic view transitions are shown in transitions between the real cameras and the synthetic camera with both two-directional transitions (shown between the real cameras on the left) and one-directional transitions shown between the cameras on the right and all the cameras and the synthetic camera. The same types of transitions exist between the theater cameras of FIG. 2.

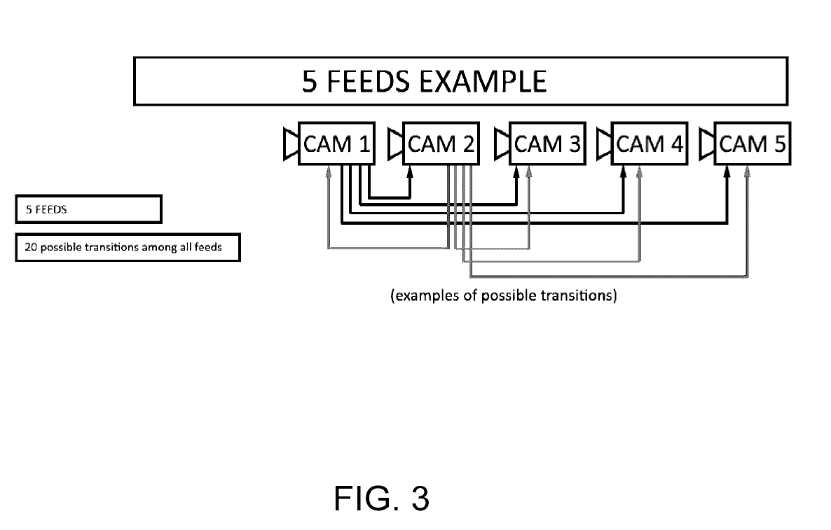

FIG. 3 shows a system with five real feeds, namely CAM1-CAM5. As can be seen by the arrows (which represent transitions), there are a total of 20 possible transitions. Determining the number of combinations between a set of objects taken two at a time is well known in mathematics. It should be noted that not all the possible transitions are shown by arrows in FIG. 3. Some arrows have been omitted for clarity. In reality, there are two transitions between each camera pair (one going one direction, the other going the opposite direction).

FIG. 4 shows the cameras of FIG. 3 representing five feeds. As previously stated, there are a total of 20 transitions possible. In this example, each possible transition is calculated at 0.5 second intervals, and the computation of each lasts for 1 second. The matrix represents double track overlapping by 0.5 seconds resulting in the progressive real-time generation of 40 transition feeds. Since, the 40 transitions are pre-computed and stored, any number of users can be serviced and each user can request any of the 40 transitions. The present invention provides the major advantage of servicing a very large number of users that may interactively request transitions.

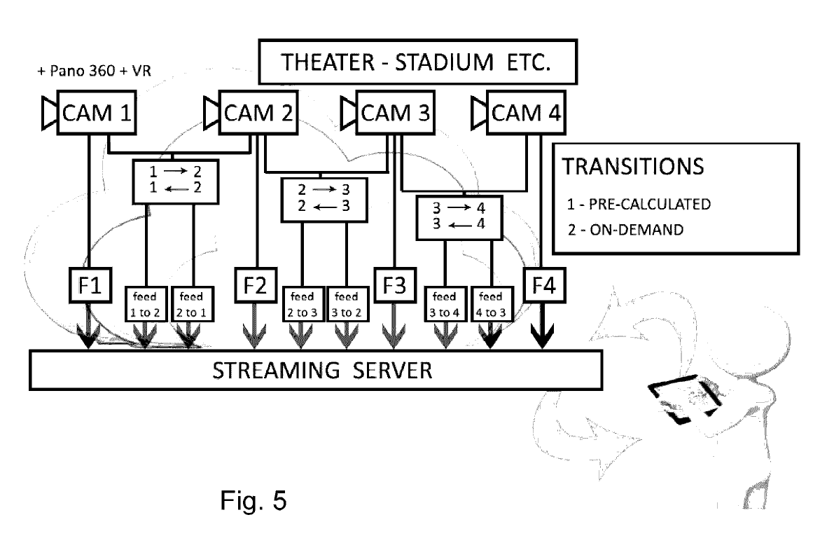

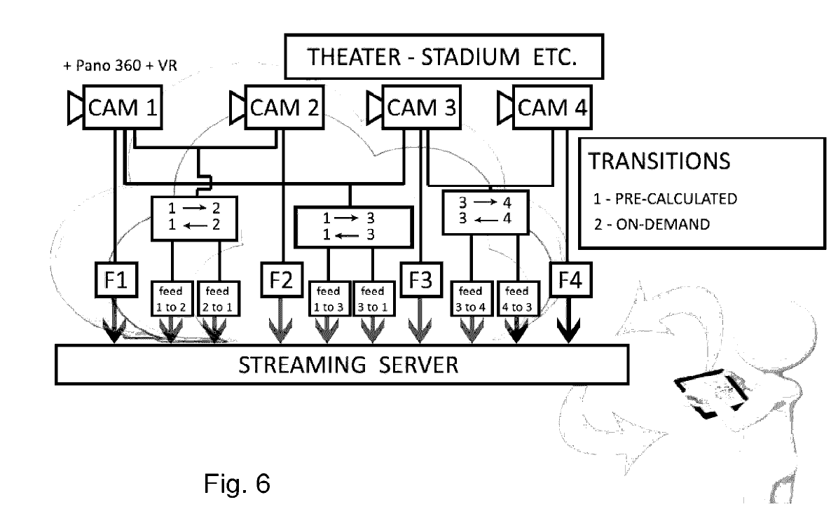

FIG. 5 shows a user interactively requesting a streaming server to provide transitions from four feeds F1, F2, F3 and F4. The following transitions are provided: 1 to 2, 2 to 1, 2 to 3, 3 to 2, 3 to 4 and 4 to 3. FIG. 6 shows a similar situation with the transitions 1 to 2, 2 to 1, 1 to 3, 3 to 1, 3 to 4 and 4 to 3. The system would progressively compute and store all possible transitions 1 to 2, 2 to 1, 1 to 3, 3 to 1, 1 to 4, 4 to 1, 2 to 3, 3 to 2, 2 to 4, 4 to 2, 3 to 4 and 4 to 3. There are six combinations of four cameras taken two at a time; however, since the transitions are bi-directional, the total is twelve. The formula reduces to N(N−1) where N is the number of real feeds.

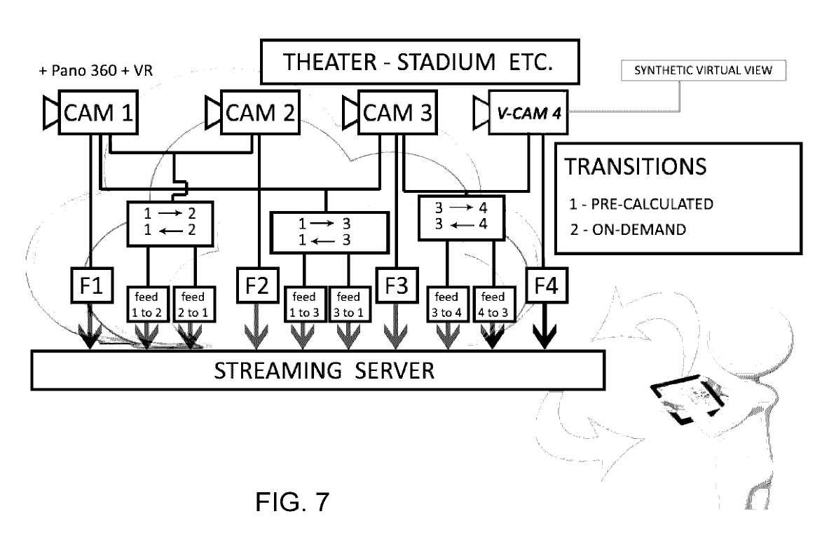

FIG. 7 shows the case where the feeds are both real and synthetic. V-CAM4 supplies a synthetic virtual view which becomes feed F4. The other three feeds F1-F3 are real feeds. Transitions between the real and synthetic feeds are shown. For example, the transitions 3-4 and 4-3 are between a real feed and a synthetic feed. The present invention includes any combination of transitions between real feeds and synthetic feeds including real-real, real-synthetic and synthetic-synthetic and vice-versa.

The present invention can be summarized as: a network audio-video streaming application with a method of generating scene synthetic view transitions in a pre-computed tri-dimensional space of a venue from among available audio-video capture feeds or streams from devices present at the venue portraying an event occurring at the venue where the steps are: determining candidate audio-video capture feeds or streams to be interpolated via synthetic view transitions; determining duration times and time intervals for said synthetic view transitions; generating said synthetic view transitions containing novel audio-video at the determined time intervals and for the determined durations in synchronization with time alignment of the audio-video capture feeds or streams, wherein the synthetic view transitions represent at least one of a plurality of possible trajectories in said tri-dimensional space of the venue; progressively incrementing newly generated audio-video data files that are time aligned with the audio-video feeds or streams portraying the event, wherein the audio-video data files contain a stacked representation of time-coherent synthetic view transitions between the determined sets of audio-video capture feeds or streams in accord with the determined durations and time intervals; dynamically updating a streaming manifest to reflect changes in file status, time alignment and availability of audio-video capture feeds or streams.

Several descriptions and illustrations have been presented to aid in understanding the present invention. One with skill in the art will recognize that numerous changes and variations may be made without departing from the spirit of the invention; in particular, the present invention may be translated to any venue with any number of feeds and any number of interactive users. Each of the changes and variations is within the scope of the present invention.

I claim:

1. In a network audio-video streaming application, a method of generating scene synthetic view transitions in a pre-computed tri-dimensional space of a venue from among available audio-video capture feeds or streams from devices present at the venue portraying an event occurring at the venue comprising:
determining candidate audio-video capture feeds or streams to be interpolated via synthetic view transitions;
determining duration times and time intervals for said synthetic view transitions;
generating said synthetic view transitions containing audio-video at the determined time intervals and for the determined durations in synchronization with time alignment of the audio-video capture feeds or streams, wherein the synthetic view transitions represent at least one of a plurality of possible trajectories in said tri-dimensional space of the venue;
progressively incrementing newly generated audio-video data files that are time aligned with the audio-video feeds or streams portraying the event, wherein the audio-video data files contain a stacked representation of time-coherent synthetic view transitions between the determined sets of audio-video capture feeds or streams in accord with the determined durations and time intervals;
dynamically updating a streaming manifest to reflect changes in file status, time alignment and availability of audio-video capture feeds or streams.

2. The method of claim 1 wherein the audio-video capture feeds or streams originate from cameras, recording devices, transmitting devices or sensors present and positioned at said venue.

3. The method of claim 1 wherein the audio-video capture feeds or streams are available scene synthetic views audio-video-data feeds or streams computed as novel static, and/or dynamic, audio-video-data streams of vantage points of the event portrayed and coherently time synchronized with the capture/recording devices at the venue;

4. The method of claim 1 wherein the duration times are predetermined.

5. The method of claim 1 wherein the duration times are variable.

6. The method of claim 1 wherein the time intervals are predetermined.

7. The method of claim 1 wherein the time intervals are variable.

8. The method of claim 1 wherein the venue is a theater, stadium, arena or street.

9. In a network audio-video streaming application, a method of generating scene synthetic view transitions in a pre-computed tri-dimensional space of a venue from among available audio-video capture feeds or streams from devices present at the venue portraying an event occurring at the venue, wherein the available audio-video capture feeds or streams are either:
audio-video-data capture feeds or streams from recording and transmitting devices and/or sensors present and positioned and portraying an event occurring at a venue; or:
available scene synthetic views audio-video-data feeds or streams computed as novel static, and/or dynamic, audio-video-data streams of vantage points of the event portrayed and coherently time synchronized with the capture/recording devices at the venue;
comprising:
determining candidate audio-video capture feeds or streams to be interpolated via synthetic view transitions;
determining duration times and time intervals for said synthetic view transitions;
generating said synthetic view transitions containing novel audio-video at the determined time intervals and for the determined durations in synchronization with time alignment of the audio-video capture feeds or streams, wherein the synthetic view transitions represent at least one of a plurality of possible trajectories in said tri-dimensional space of the venue;
progressively incrementing newly generated audio-video-data files that are time aligned with the audio-video feeds or streams portraying the event, wherein the audio-video data files contain a stacked representation of time-coherent synthetic view transitions between the determined sets of audio-video capture feeds or streams in accord with the determined durations and time intervals;
dynamically updating a streaming manifest to reflect changes in file status, time alignment and availability of audio-video capture feeds or streams.

10. The method of claim 9 wherein the duration times are predetermined.

11. The method of claim 9 wherein the duration times are variable.

12. The method of claim 9 wherein the time intervals are predetermined.

13. The method of claim 9 wherein the time intervals are variable.

14. The method of claim 9 wherein the venue is a theater, stadium, arena or street.

15. A method for generation of scene synthetic views audio-video-data feeds or streams computed as novel static and/or dynamic audio-video-data streams representing vantage points of an event taking place at a venue portrayed and coherently time synchronized with audio-video-data streams of the devices and sensors at the venue comprising:
determining at least one of all the possible spatial trajectories in a pre-computed tri-dimensional space of the venue at fixed or variable time and space intervals;
determining candidate scene synthetic view static and/or dynamic paths;
progressive incrementing newly generated audio-video-data files or streams time aligned with other audio-video-data feeds portraying the event, said newly generated audio-video files containing a stacked representation of time coherent synthetic views in accord with predetermined or variable durations, time intervals and spatial trajectories.
dynamically updating a streaming manifest to reflect the changes in files status, time alignment and feeds availability.

16. The method of claim 15 wherein said trajectories are pre-programmed.

17. The method of claim 15 wherein said trajectories are client/user requested.

18. The method of claim 15 further comprising supplying a user interface where, interaction includes at least touch, voice and gesture inputs, wherein the user interface interprets a user's input to determine a path towards a desired direction in the tri-dimensional space, wherein synchronized synthetic view transition audio-video data blocks are streamed without audio or video interruption portraying a feeling of moving inside the space where the event being depicted occurs.

19. The method of claim 15 wherein the duration times are variable.

20. The method of claim 15 wherein the time intervals are variable.
